(19) United States
(12) Patent Application Publication
(10) Pub. No.: US 2012/0267447 A1
(43) Pub. Date: Oct. 25, 2012

(54) ENVIRONMENTAL AND BIOTIC-BASED SPEED MANAGEMENT AND CONTROL OF MECHANIZED IRRIGATION SYSTEMS

(76) Inventor: KEVIN ABTS, Omaha, NE (US)

(21) Appl. No.: 13/534,754

(22) Filed: Jun. 27, 2012

Related U.S. Application Data
(63) Continuation of application No. 12/221,752, filed on Aug. 6, 2008.

(51) Int. Cl. A01G 25/16

(52) U.S. Cl. 239/69; 239/728; 239/743

(57) ABSTRACT

A system that based on changes in agricultural crop or plant characteristics or dynamics, e.g. heat stress, water deficit stress, stem growth, leaf thickness, plant color, nutrient composition, etc., or changes in environmental conditions, e.g., temperature, wind, pressure, relative humidity, dew point, precipitation, soil moisture, solar radiation, etc. or a combination of both, e.g., evapotranspiration, either automatically increases or decreases the speed or rate of movement or rotation of a mechanized irrigation system, e.g. center pivot, corner, linear, or lateral move irrigation system or similar, or reports a recommended increased or decreased speed or rate of movement or rotation of a mechanized irrigation system either directly or indirectly to the end user. The system responds directly or indirectly to data outputted from monitoring systems that gather and compile environmental (non-biotic), biotic or similar information from agricultural fields and crops.

### CROSS REFERENCE TO RELATED APPLICATION

This is a Continuation of application Ser. No. 12/221,752, filed Aug. 6, 2008, entitled ENVIRONMENTAL AND BIOTIC-BASED SPEED MANAGEMENT AND CONTROL OF MECHANIZED IRRIGATION SYSTEMS

### BACKGROUND OF THE INVENTION

1. Field of the Invention

This invention relates to the speed management and control of mechanized irrigation systems and more particularly to a system that based on changes in agricultural crop or plant characteristics or dynamics, either automatically increases or decreases the speed or rate of movement or rotation of the irrigation system or reports a recommended increased or decreased speed of rotation to the end user.

2. Description of the Related Art

Mechanized or self-propelled irrigation systems having elevated water booms are generally classified as either a center pivot irrigation system or as a laterally moving system which is also referred to as a lateral irrigation system, a linear irrigation system or an in-line irrigation system. In many instances, the center pivot irrigation systems include corner systems for irrigating the corners of a field. Normally, the irrigation systems include spaced-apart drive units or towers which not only support the water boom or water pipeline above the field but which also move the system over the field to be irrigated. Usually, in a center pivot irrigation machine, the last regular drive unit (L.R.D.U.) is the master drive unit which is driven at a pre-set speed with the other drive units being “slave” drive units which are operated through an alignment system so that the drive units remain in a general alignment with each other. The speed of the master drive unit is set by a master percent timer which is manually set at the center pivot. The speed of the master drive unit remains constant until the system is deactivated or the master percent timer is manually adjusted so as to speed up the system or slow the speed of the system.

In the lateral move or linear systems, any of the drive units may be the master drive unit, the speed of which is controlled by a master percent timer in the same fashion as in the center pivot irrigation systems.

Many of the mechanized irrigation systems may be remotely controlled so as to begin irrigation or to halt irrigation. However, the activation and deactivation of the irrigation systems are usually based upon an operator's visual observation of the condition of the crop. In some instances, moisture sensors, leaf sensors or the like are placed in the field to warn the operator that the crop is in stress or is being over watered, at which time the operator will either activate the irrigation system or deactivate the system. To the best of Applicant's knowledge, a system has not been previously developed which will either automatically increase the speed of the irrigation machine or decrease the speed of the irrigation machine which is a better response to crop conditions than either starting or stopping the irrigation system:

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A system that based on changes in agricultural crop or plant characteristics or dynamics, e.g. heat stress, water deficit stress, stem growth, leaf thickness, plant color, nutrient composition, etc., or changes in environmental conditions, e.g., temperature, wind, pressure, relative humidity, dew point, precipitation, soil moisture, solar radiation, etc. or a combination of both, e.g., evapotranspiration, either automatically increases or decreases the speed or rate of movement or rotation of a mechanized irrigation system, e.g. center pivot, corner, linear, or lateral move irrigation system or similar systems, or reports a recommended increased or decreased speed or rate of movement or rotation of a mechanized irrigation system either directly or indirectly to the end user. The system responds directly or indirectly to data outputted from monitoring systems that gather and compile environmental (non-biotic), biotic or similar information from agricultural fields and crops. The system is comprised of an algorithm, table or the like that computes, calculates or otherwise determines an optimal control speed based on real-time or historical field and crop data as well as irrigation management parameters i.e., water application depth, time averages, information thresholds, weather forecasts, etc. that can be optionally configured by the end user, downloaded from the web or inputted from remote irrigation management systems. The recommended control speed is then either reported to the end user via the World Wide Web, mobile Web, email, personal computer, SMS (short message service), MMS (multimedia message service), pager, manual or automated voice phone call out, RF (radio frequency) communication device or similar or automatically activates a speed timer, percent timer, percent rate timer, or speed control device or similar of the corresponding mechanized irrigation system at the recommended control speed. This system provides optimal irrigation application management that conserves water resources by reducing wasteful overwatering, ensures against irreversible crop damage resulting from both overwatering and underwatering and increases total farm output and profitability by improving overall quality, yield and management of agricultural crops.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified;

FIG. 1 is a perspective view of a conventional center pivot irrigation system;

FIG. 2 is a schematic drawing illustrating a center pivot irrigation system with field sensors positioned in the field being irrigated;

FIG. 3 is an overview block diagram;

FIG. 4 is a block diagram of the speed control device of this invention;

FIG. 5 is a block diagram of Stage 1 of this invention;

FIG. 6 is a block diagram of Stage 2 of this invention;

FIG. 7 is a block diagram of Stage 3a of this invention;

FIG. 8 is a block diagram of Stage 3b of this invention;

FIG. 9 is a block diagram of Stage 4 of this invention; and

FIG. 10 is a printout of an algorithm which combines heat stress time threshold data with user defined parameters.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

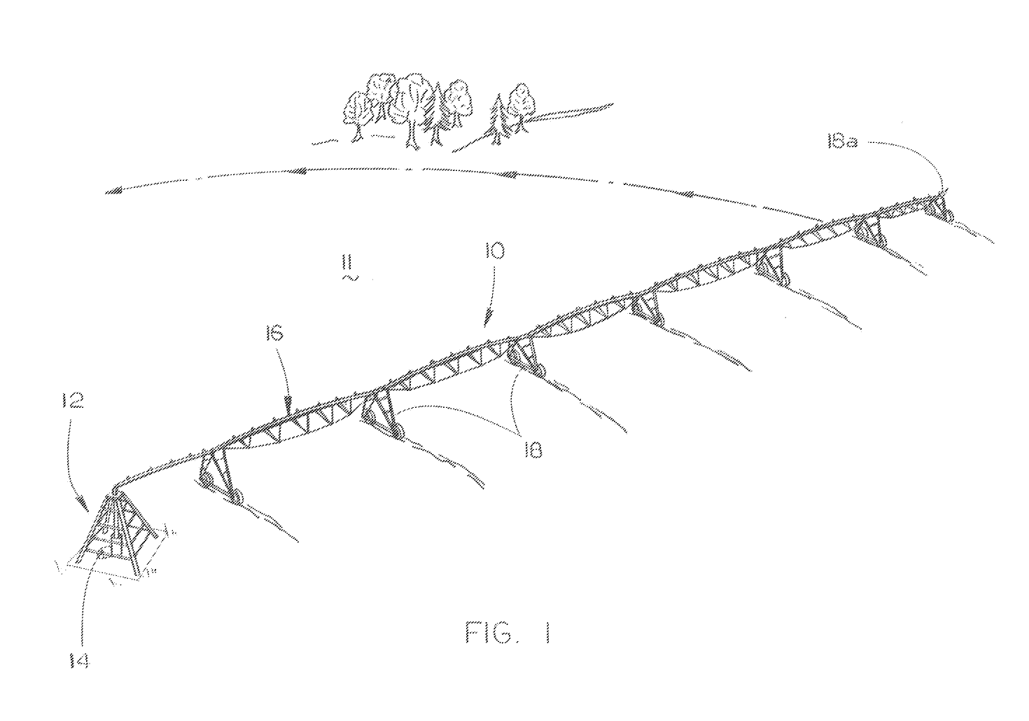

In FIG. 1, the numeral 10 refers to a conventional center pivot irrigation system having a center pivot structure 12 at its inner end. Center pivot structure 12 includes a vertically disposed water pipe 14 which is in communication with a source of water under pressure. An elevated water boom or pipeline 16 is pivotally connected at its inner end to the center pivot structure 12 with the pipeline 16 being in fluid communication with water pipe 14. The pipeline 16 is supported by a plurality of spaced-apart drive units or towers 18 in conventional fashion. The numeral 18a refers to the last regular drive unit (L.R.D.U.) which usually is the master tower. A master percent timer is operatively connected to the electric motor on L.R.D.U. 18a which either activates the moment of L.R.D.U. 18a or deactivates the same in conventional fashion. It is the type of mechanized irrigation system shown in FIG. 1 that the speed management system 20 of this invention will be used. The speed management system 20 may be used with other types of mechanized irrigation systems such as corner systems, linear systems or lateral move irrigation systems or the like.

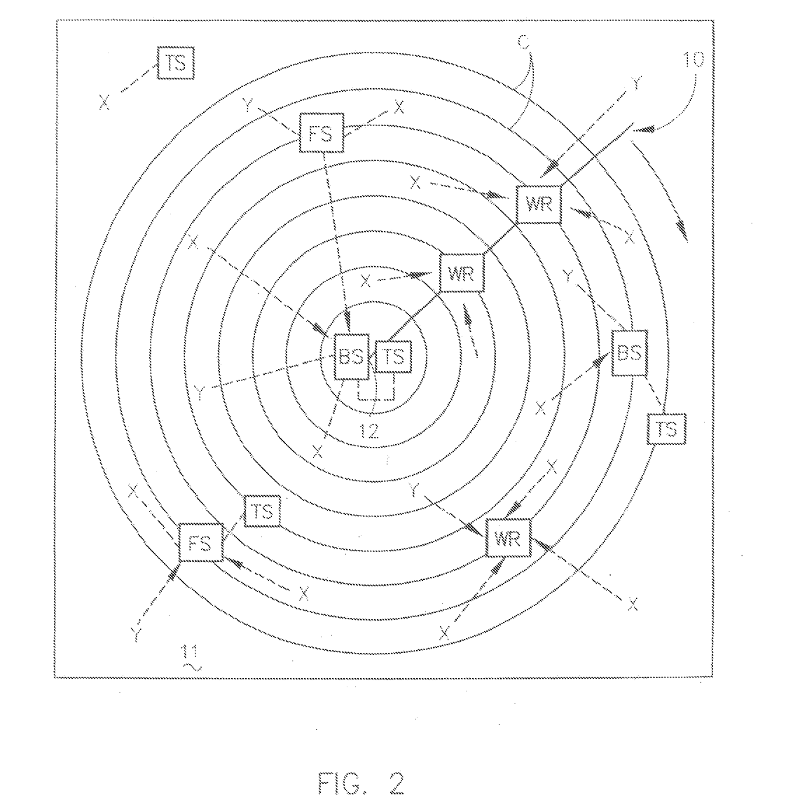

Referring to FIG. 2, the center pivot irrigation system 10 is positioned in the field 11 and travels in a clockwise direction around the center pivot structure 12. The circles C represent the path that each of the drive units 18 will take as they move through the field 11.

A base station BS with a processor is located in the field 11, on the irrigation system 10 or at a remote site such as a computer, web server and/or similar device. A telemetry system TS is preferably positioned adjacent the base station BS for remote two-way data communication to a personal computer, web server and/or similar device. A plurality of field stations FS are located in the field 11 and are either hand wired or wireless so as to receive data and transmit the same. Telemetry systems TS are also located adjacent the field stations FS for transmitting data to a personal computer, web server and/or similar device.

A plurality of wireless receivers WR are either mounted on the system 10 or in the field 11 for collecting field sensor data. A plurality of biotic field sensors X, either wired or wireless, are provided for data transmission. A plurality of environmental (non-biotic) field sensors, either wired or wireless, are provided for data transmission.

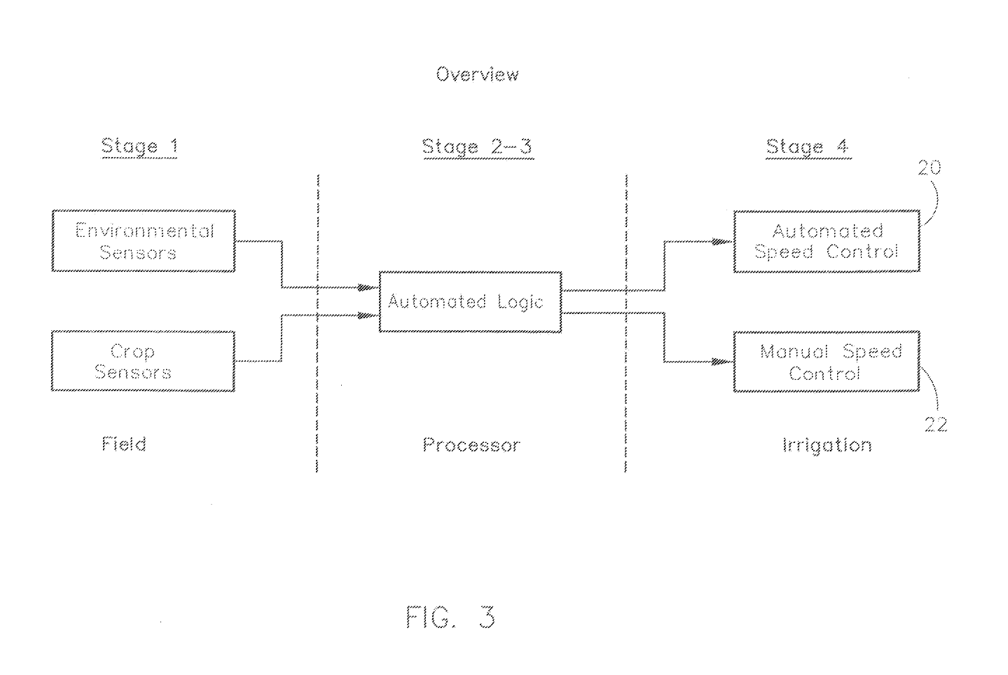

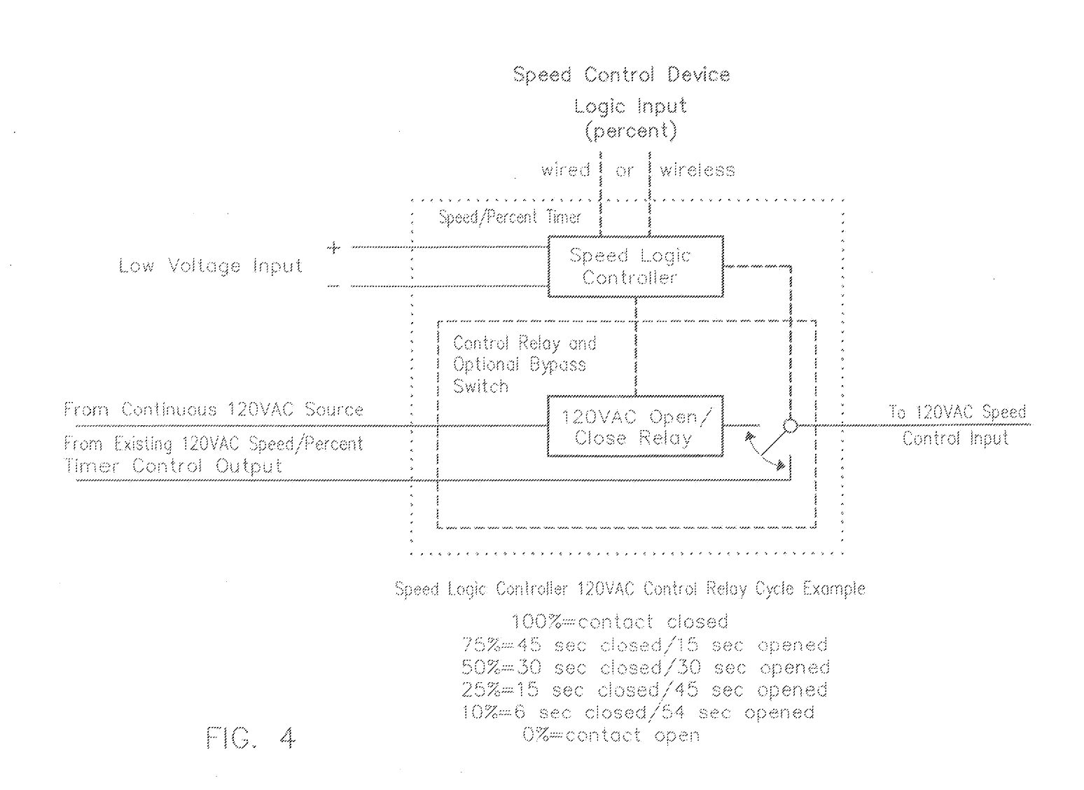

In the overview block diagram of FIG. 3, it can be seen that the data from the environmental sensors and crop sensors in the field 11 is transmitted to a processor having automated logic which in turn transmits central signals to an automatic speed control device 20 and to a manual speed control device 22 for the irrigation system 10. FIG. 4 illustrates the operation of the speed control devices 20 and 22. FIG. 5 depicts stage 1 of the operation of the instant invention. As seen, environmental data is collected by the environmental field sensors. Data is collected concerning temperature, moisture levels, nutrient composition, moisture depths, water evaporation and moisture holding capacity. Data is also collected regarding climate such as precipitation amounts, solar radiation, barometric temperature, vector wind speed, air temperature, relative humidity, vector wind direction, dew point temperature and frost. Crop data is collected by the field sensors FS relating to the crop plant such as water transpiration, leaf thickness, nutrient composition, internal canopy temperature, leaf wetness, heat or water deficit stress, external canopy temperature, plant growth and color change.

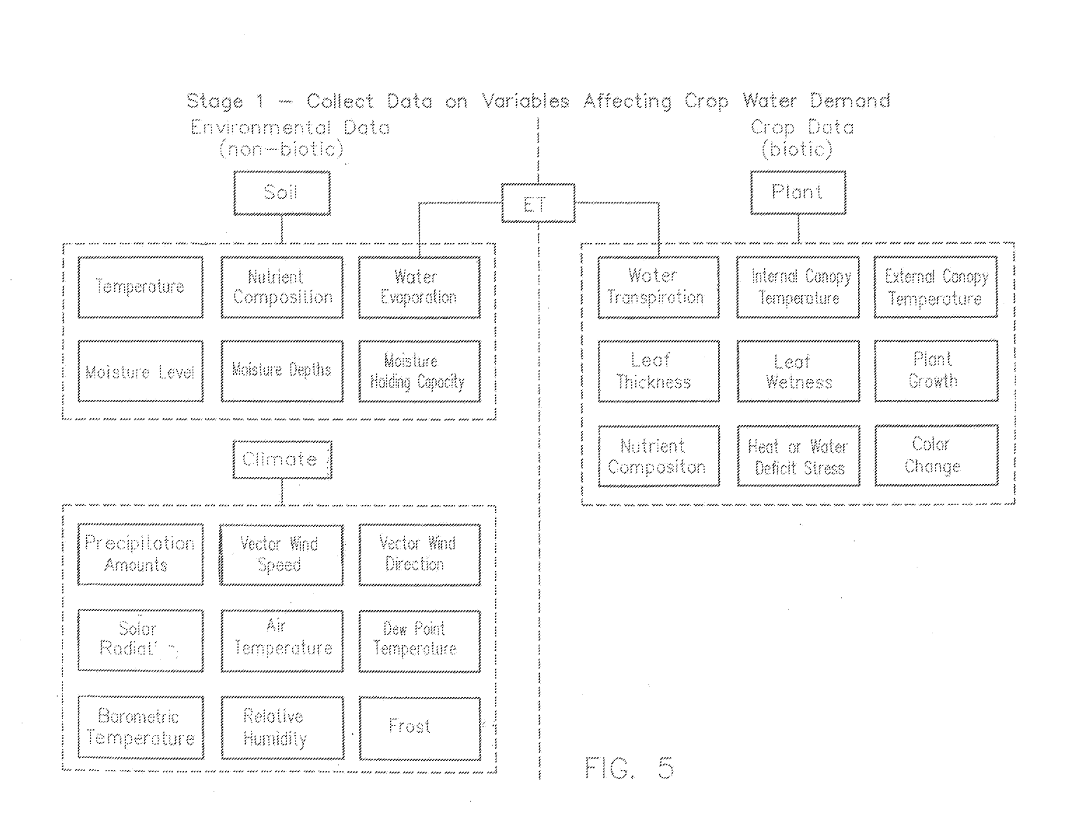

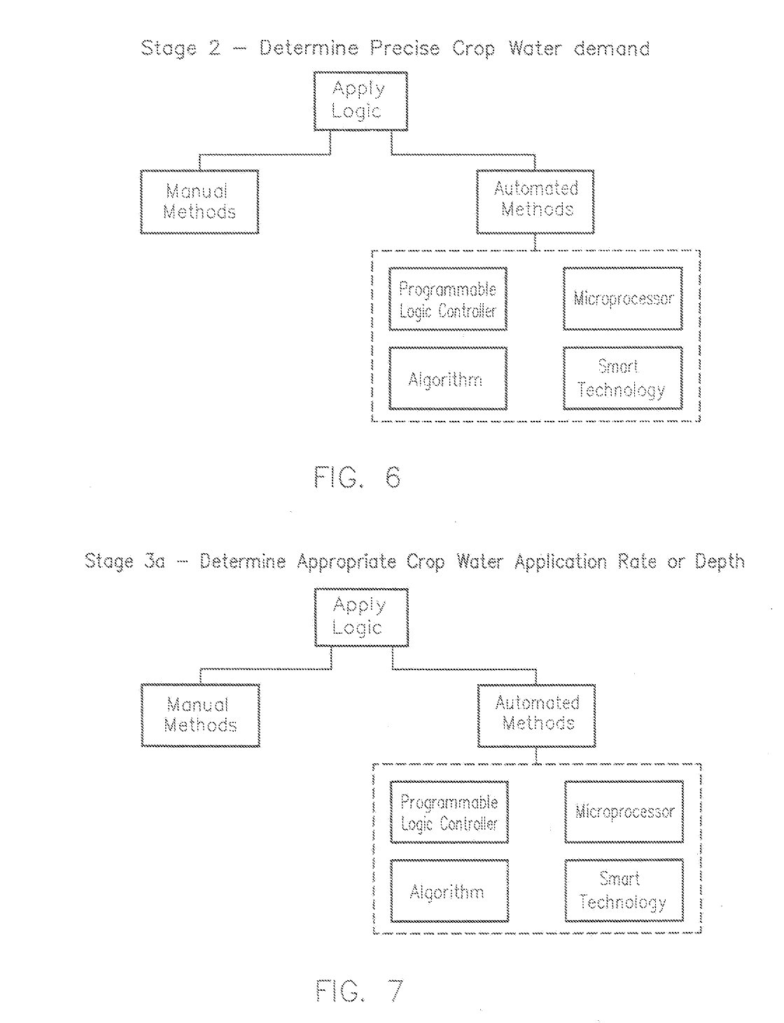

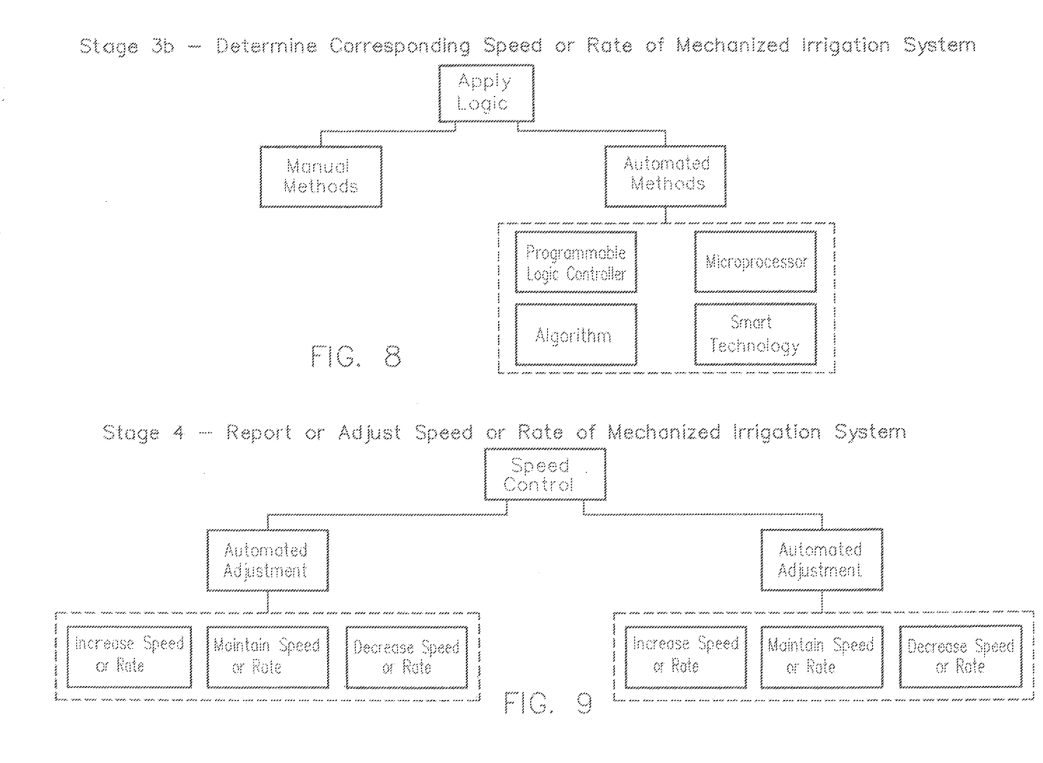

After the data has been collected as illustrated in Stage 1 (FIG. 5), the computer applies logic with respect to manual and automated crop water demand as illustrated in Stage 2 (FIG. 6). Stage 3a (FIG. 7) illustrates the manner in which the appropriate crop water application rate or depth is determined. FIG. 8 (Stage 3b) illustrates the manner in which the corresponding speed or rate of the irrigation system is determined. After the speed or rate of the irrigation system is determined in Stage 3b, that information is either reported to the end user for manual adjustment of the speed of the irrigation system or the speed of the irrigation system is automatically adjusted as seen in Stage 4 (FIG. 9).

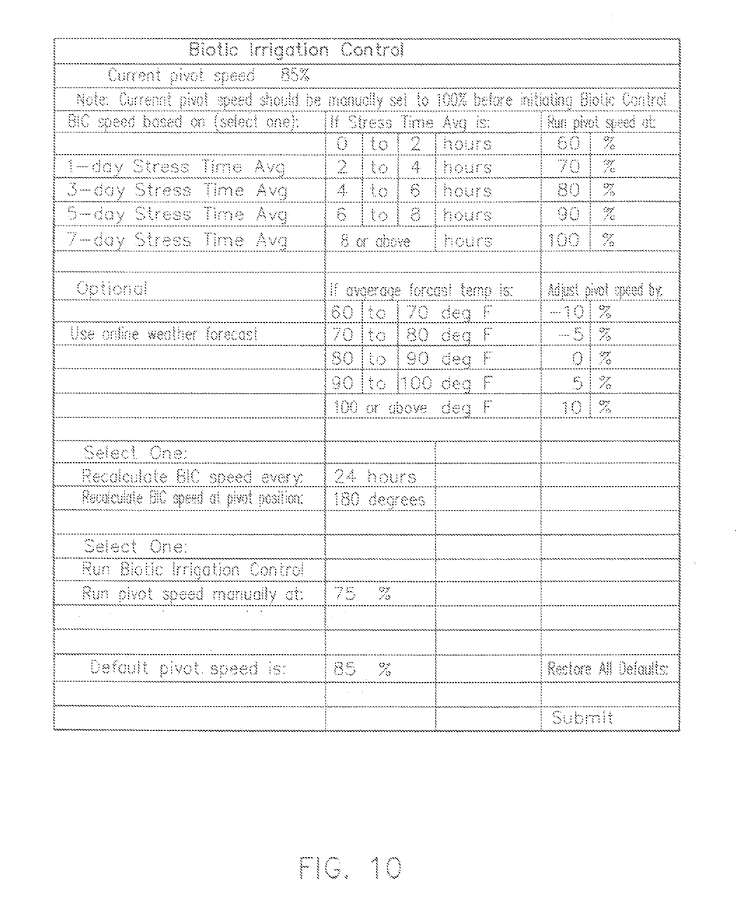

FIG. 10 illustrates a biotic control algorithm that combines heat stress time threshold data with user defined parameters.

Thus it can be seen that a system has been provided for sensing crop conditions, determining irrigation water needs, and then either reporting to the end user the proper speed at which the irrigation system should be operated or to automatically adjust the speed of the irrigation system according to the collected data.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. In combination:
a mechanized, self-propelled irrigation system which is moving over an agricultural field or crop or plant area to be irrigated;
a speed controller associated with said irrigation system which controls the speed of the irrigation system passing over the field or crop or plant area to be irrigated;
at least one stationary field sensor in the field or crop or plant area over which the irrigation system passes;
said stationary field sensor being in communication with said controller which will either automatically increase the speed of the irrigation system or decrease the speed of the irrigation system to continuously apply varying amounts of water to the area being irrigated in response to changes in field or crop or plant conditions as sensed by said stationary field sensor.

2. The combination of claim 1 wherein said sensor is a heat stress sensor.

3. The combination of claim 1 wherein said sensor is a water deficit stress sensor.

4. The combination of claim 1 wherein said sensor is a stem growth sensor.

5. The combination of claim 1 wherein said sensor is a leaf thickness sensor.

6. The combination of claim 1 wherein said sensor is a plant turgidity sensor.

7. The combination of claim 1 wherein said sensor is a plant color sensor.

8. The combination of claim 1 wherein said sensor is a nutrient composition sensor.

9. The combination of claim 1 wherein said sensor is a temperature sensor.

10. The combination of claim 1 wherein said sensor is a wind sensor.

11. The combination of claim 1 wherein said sensor is a pressure sensor.

12. The combination of claim 1 wherein said sensor is a relative humidity sensor.

13. The combination of claim 1 wherein said sensor is a dew point sensor.

14. The combination of claim 1 wherein said sensor is a precipitation sensor.

15. The combination of claim 1 wherein said sensor is a soil moisture sensor.

16. The combination of claim 1 wherein said sensor is a solar radiation sensor.

17. In combination:
a mechanized, self-propelled irrigation system which is moving over an agricultural field or crop or plant area to be irrigated;
a speed controller associated with said irrigation system which controls the speed of the irrigation system passing over the field or crop or plant area to be irrigated;
at least one stationary sensor in the field or crop or plant area over which the irrigation system passes;
said speed controller being capable of increasing the speed of the irrigation system or decreasing the speed of the irrigation systems to continuously apply varying amounts of water to the area being irrigated in responses to changes in field or crop or plant information;
a communication device associated with said stationary sensor;
said stationary sensor supplying field or crop or plant information to said communication device to indicate a suggested rate of speed of said irrigation system to the end user of the irrigation system.

18. The combination of claim 16 wherein said sensor is a heat stress sensor.

19. The combination of claim 16 wherein said sensor is a water deficit stress sensor.

20. The combination of claim 16 wherein said sensor is a stem growth sensor.

21. The combination of claim 16 wherein said sensor is a leaf thickness sensor.

22. The combination of claim 16 wherein said sensor is a plant turgidity sensor.

23. The combination of claim 16 wherein said sensor is a plant color sensor.

24. The combination of claim 16 wherein said sensor is a nutrient composition sensor.

25. The combination of claim 16 wherein said sensor is a temperature sensor.

26. The combination of claim 16 wherein said sensor is a wind sensor.

27. The combination of claim 16 wherein said sensor is a pressure sensor.

28. The combination of claim 16 wherein said sensor is a relative humidity sensor.

29. The combination of claim 16 wherein said sensor is a dew point sensor.

30. The combination of claim 16 wherein said sensor is a precipitation sensor.

31. The combination of claim 16 wherein said sensor is a soil moisture sensor.

32. The combination of claim 16 wherein said sensor is a solar radiation sensor.
